(19) United States
(12) Patent Application Publication
(10) Pub. No.: US 2007/0277605 A1
(43) Pub. Date: Dec. 6, 2007

(54) Shield assembly for a gas sensor

(76) Inventors: Richard E. Fouts, Frankenmuth, MI (US); Bruce W. Holleboom, Grand Blanc, MI (US)

Correspondence Address: DELPHI TECHNOLOGIES, INC., M/C 480-410-202, PO BOX 5052, TROY, MI, 48007, US

(21) Appl. No.: 11/444,713

(22) Filed: Jun. 1, 2006

(51) Int. Cl. G01D 11/24

(52) U.S. Cl. 73/431

(57) ABSTRACT

A shield assembly for protecting a sensing element of a gas sensor, the shield assembly includes an outer shield comprising an elongated outer wall and an inner shield comprising an inner elongated wall. The elongated outer wall includes a first end, a second end, and a tip portion disposed across the second end of the outer wall. The tip portion includes at least one elongated aperture extending therethrough and the elongated outer wall is configured to not have any openings between the first end and the second end. The inner elongated wall is disposed within the elongated outer wall. The inner elongated wall includes a first open end, a second open end, and a flange portion extending from a periphery of the first open end of the inner elongated wall. The flange portion is configured to make contact with the elongated outer wall when the inner elongated wall is inserted therein and the second open end makes contact with the tip portion to define a thermal barrier comprising a cavity located between the inner elongated wall and the elongated outer wall, wherein convection losses from an interior region defined by the inner elongated wall, to the elongated outer wall, are slowed by heated fluid disposed in the cavity between the elongated outer wall and the inner elongated wall.

### TECHNICAL FIELD

The present invention relates to a gas sensor having a shield assembly. More particularly, the present invention relates to a shield assembly for covering a sensing member of the gas sensor.

### BACKGROUND

Oxygen sensors are used in a variety of applications that require qualitative and quantitative analysis of gases. In automotive applications, the direct relationship between oxygen concentration in the exhaust gas and air to fuel ratio (A/F) of the fuel mixture supplied to the engine allows the oxygen sensor to provide oxygen concentration measurements for determination of optimum combustion conditions, maximization of fuel economy, and management of exhaust emissions.

One type of sensor uses an ionically conductive solid electrolyte between porous electrodes. For oxygen sensing, solid electrolyte sensors are used to measure oxygen activity differences between an unknown gas sample and a known gas sample. In the use of a sensor for automotive exhaust, the unknown gas is exhaust and the known gas, (i.e., reference gas), is usually atmospheric air because the oxygen content in air is relatively constant and readily accessible. This type of sensor is based on an electrochemical galvanic cell operating in a potentiometric mode to detect the relative amounts of oxygen present in an automobile engine's exhaust. When opposite surfaces of this galvanic cell are exposed to different oxygen partial pressures, an electromotive force (“emf”) is developed between the electrodes according to the Nernst equation.

With the Nernst principle, chemical energy is converted into electromotive force. A gas sensor based upon this principle typically consists of an ionically conductive solid electrolyte material, a porous electrode with a porous protective overcoat exposed to exhaust gases (“exhaust gas electrode”), and a porous electrode exposed to a known gas' partial pressure (“reference electrode”). Sensors typically used in automotive applications use a yttrium stabilized zirconia based electrochemical galvanic cell with porous platinum electrodes, operating in potentiometric mode, to detect the relative amounts of a particular gas, such as oxygen for example, that is present in an automobile engine's exhaust. Also, a typical sensor has a ceramic heater attached to help maintain the sensor's ionic conductivity. As such, the heater is used to heat the sensor up to an operational temperature. When opposite surfaces of the galvanic cell are exposed to different oxygen partial pressures, an electromotive force is developed between the electrodes on the opposite surfaces of the zirconia wall, according to the Nernst equation:

$$E = ( \frac{RT}{4 F} ) ln ( \frac{{P}_{o2}^{ref}}{{P}_{o2}} )$$

Due to the large difference in oxygen partial pressure between fuel rich and fuel lean exhaust conditions, the electromotive force (emf) changes sharply at the stoichiometric point, giving rise to the characteristic switching behavior of these sensors. Consequently, these potentiometric oxygen sensors indicate qualitatively whether the engine is operating fuel-rich or fuel-lean, conditions without quantifying the actual air-to-fuel ratio of the exhaust mixture. Oxygen sensors measure all of the oxygen present in the exhaust to make the correct determination when the oxygen content (air) exactly equals the hydrocarbon content (fuel).

Oxygen sensors include a ceramic sensing element that is brought up to an operational temperature by a heater, which is necessary for the sensor's ionic conductivity. The heated sensing element is sensitive to water in the exhaust system. Traditionally, heated oxygen sensors have been subject to internal ceramic element cracking, especially in sensors disposed down stream from the catalytic converter, induced by condensate water in the exhaust. Water enters a vehicle's exhaust system, including the gas sensor, due to condensation of combustion byproducts. As a result, the heated sensing element may be subject to ceramic cracking when the water contacts the hot element. The sudden impact of liquid water will cause severe thermal shock and cracking of the element, causing irreparable damage to the sensor. The problem has been sought to be rectified through special protective shields in the exhaust system or changes in the exhaust configuration.

Various vehicle and sensor shields and other techniques have been tried to limit this problem. These include special heater control circuits and modified sensor shields. Such remedies typically increase vehicle or sensor complexity, adding to cost of production. Vehicle shields have met with some success but, when incorrectly designed, have actually made the problem worse.

Traditionally, the typical oxygen sensor shield design used holes or openings of a louvered shape along the sides of the shield aligned with the direct flow of the exhaust gas to direct gas toward the sensing element. These designs, although not complex, do not provide sufficient protection against water impingement to the sensor. In addition, and due to their location, these openings may also become clogged by particles entrained in the exhaust gas. Morover, and depending on the engine coupled to the exhaust system (e.g. diesel vs. gasoline), the exhaust gases vary dramatically in temperature as well as cold and hot start conditions. Thus and depending on the engine type, different ranges are required to heat the sensor to an operational temperature.

A second problem associated with liquid water impingement upon the sensor has also been detected. If the ceramic sensing element becomes wetted, the time to heat it to operating temperature is greatly extended. The ceramic element typically operates at minimum temperatures of 300° C. to 400° C., depending on sensor design and requirements, for satisfactory function.

Typically, the shield protects the fragile ceramic sensing element from mechanical damage, exhaust impact, and other foreign materials and contaminants while allowing entrance of a sufficient amount of gas to promote productive exhaust sensing.

Accordingly, it is desirable to provide a shield assembly for a sensing element or member of a gas sensor, wherein the shield assembly provides protection for the sensing member from contaminates as well as minimizing the time and power required to heat the sensing member to a desired or operational temperature range and maintain that temperature.

### SUMMARY OF THE INVENTION

A shield assembly for protecting a sensing element of a gas sensor in accordance with an exemplary embodiment is provided. The shield assembly includes an outer shield comprising an elongated outer wall and an inner shield comprising an inner elongated wall. The elongated outer wall includes a first end, a second end, and a tip portion disposed across the second end of the outer wall. The tip portion includes at least one elongated aperture extending therethrough and the elongated outer wall is configured to not have any openings between the first end and the second end. The inner elongated wall is disposed within the elongated outer wall. The inner elongated wall includes a first open end, a second open end, and a flange portion extending from a periphery of the first open end of the inner elongated wall. The flange portion is configured to make contact with the elongated outer wall when the inner elongated wall is inserted therein and the second open end makes contact with the tip portion to define a thermal barrier comprising a cavity located between the inner elongated wall and the elongated outer wall, wherein convection losses from an interior region defined by the inner elongated wall, to the elongated outer wall, are slowed by heated fluid disposed in the cavity between the elongated outer wall and the inner elongated wall.

A gas sensor in accordance with another exemplary embodiment is provided. The gas sensor includes an outer shell, a sensing member extending from the outer shell, and a shield assembly coupled to the outer shell. The shield assembly includes an outer shield comprising an elongated outer wall and an inner shield comprising an inner elongated wall. The elongated outer wall includes a first end, a second end, and a tip portion disposed across the second end of the outer wall. The tip portion includes at least one elongated aperture extending therethrough and the elongated outer wall is configured to not have any openings between the first end and the second end. The inner elongated wall is disposed within the elongated outer wall. The inner elongated wall includes a first open end, a second open end, and a flange portion extending from a periphery of the first open end of the inner elongated wall. The flange portion is configured to make contact with the elongated outer wall when the inner elongated wall is inserted therein and the second open end makes contact with the tip portion to define a thermal barrier comprising a cavity located between the inner elongated wall and the elongated outer wall, wherein convection losses from an interior region defined by the inner elongated wall, to the elongated outer wall, are slowed by heated fluid disposed in the cavity between the elongated outer wall and the inner elongated wall.

A method for limiting convection losses in a gas sensor in accordance with another exemplary embodiment is provided. The method includes heating a fluid in an interior region disposed between an elongated outer wall of an outer shield and an inner elongated wall of an inner shield disposed within the outer shield, wherein convection losses from an interior region defined by the inner elongated wall, to the elongated outer wall, are slowed by the heated fluid disposed in the interior region between the elongated outer wall and the inner elongated wall.

### BRIEF DESCRIPTION OF THE DRAWINGS

FIG. 1 is a cross-sectional view of a gas sensor having a shield assembly in accordance with an exemplary embodiment of the present invention;

FIG. 2 is a perspective view of the shield assembly utilized with the gas sensor of FIG. 1 in accordance with an exemplary embodiment;

FIG. 3 is a top view of the shield assembly of FIG. 2 taken along lines 3-3;

FIG. 4 is a sectional view of the shield assembly of FIG. 3 taken along lines 4-4;

FIG. 5 is a partial view of a tip portion of the shield assembly of FIG. 2 taken along lines 5-5 illustrating an opening in accordance with another exemplary embodiment;

FIG. 6 is a partial view of a tip portion of the shield assembly of FIG. 2 taken along lines 6-6 illustrating an opening in accordance with another exemplary embodiment;

FIG. 7 is a partial view of a tip portion of the shield assembly of FIG. 2 taken along lines 7-7 illustrating an opening in accordance with another exemplary embodiment;

FIG. 8 is a perspective view of an inner shield utilized in the shield assembly of FIG. 2 in accordance with an exemplary embodiment;

FIG. 9 is a top view of the inner shield of FIG. 8 taken along lines 9-9;

FIG. 10 is a sectional view of the inner shield of FIG. 9 taken along lines 10-10;

FIG. 11 is a perspective view of an inner shield in accordance with another exemplary embodiment; and

FIG. 12 is a sectional view of the inner shield of FIG. 11 taken along lines 12-12.

### DETAILED DESCRIPTION OF EXEMPLARY EMBODIMENTS

The present application is related to U.S. Pat. No. 6,691,553, the contents of which are incorporated by reference herein in its entirety.

In an exemplary embodiment, a shield assembly is disposed over a portion of a sensing element or member of an oxygen gas sensor disposed within an exhaust gas stream of a vehicle. The shield assembly is a dual shield design, wherein an inner shield is disposed within an outer shield. The sensing member depends away from a shell portion of the gas sensor into a region of the shield assembly. The shield assembly is secured to the shell portion via any suitable attachment process. For example, the shield assembly is secured to the shell portion by a cold forming process. The opposite end of the sensing member may be electrically connected to a wiring harness that communicates with the vehicle when installed therein.

During operation, the gas sensor is exposed to the exhaust gas stream wherein the sensing member is in operable communication with the vehicle via a wiring harness. Exhaust gas enters into the shield assembly through an opening disposed in a tip portion of the shield assembly. The opening in the tip portion is not aligned with the directional flow of an exhaust gas the sensor is disposed in. Exhaust gas that has passed through an opening in the tip portion flows along a non-tortuous path into the region of the shield assembly proximate the sensing member.

The sensing member communicates data to the vehicle for determining a concentration of components of the exhaust gas that contacts the sensing member, for example, whether the exhaust gas is fuel rich, fuel lean, and/or the concentration of one or more components of the exhaust gas stream. Exemplary embodiments of the shield assembly disclosed herein aid in maintaining the sensing member at an elevated temperature, so the oxygen gas sensor communicates data to the vehicle in an optimum response time.

In an exemplary embodiment, a cavity of the inner shield surrounding a portion of the sensing member is heated to an elevated temperature by a heater of the sensing element and in some instances the exhaust gases from the exhaust gas stream of the vehicle. In addition, an interior region or cavity between the inner shield and outer shield is also heated to an elevated temperature, wherein the shield assembly is configured to retain the heat comprising heated gases disposed in the cavity between the inner and outer shield. When an engine of a vehicle is then placed in a non-operating condition, heated exhaust gases do not flow into the cavity and the heater of the sensor is turned off thus, the temperature within the cavity begins to reduce due to heat loss from the cavity. The temperature within the interior region (between the inner and outer shield) tends to remain higher than a temperature within the cavity of the inner shield for a longer period of time because the interior region is substantially closed or in one embodiment completely closed as compared to the cavity of the inner shield. Heat within the interior region functions as a thermal barrier or blanket to aid in maintaining the sensing member within the cavity of the inner shield within a desired temperature range or hotter than a single wall design or dual wall design with openings in the side wall of the outer shield, wherein the openings are aligned with an exhaust flow path. Thus, convection losses from the cavity of the inner shield to the outer shield are slowed by heated fluid disposed in the interior region between the inner shield and the outer shield.

Exemplary embodiments of the shield assembly can be used in applications where the gas sensor is used for exhaust gases having relatively low temperatures, for example exhaust gases from a diesel engine. In such applications, the dual shield design provides an advantage in that the thermal barrier maintains a higher temperature level in the cavity of the inner shield proximate the sensing member compared to the temperature of the cooler exhaust gases entering the cavity. Therefore, the “time to activity” or “light-off-time” (e.g., time required for heating the element to an operation temperature) is shortened. As used herein, “light-off-time” refers to the time required for a sensor to be become functional from a cold start condition and “time to activity” refers to the time required for a sensor to become functional in air without engine exhaust or other gas exposure.

This time will, of course, depend on the length of time the heater has been turned off and how long since the heated exhaust gases have been exposed to the shield assembly.

However, and in accordance with an exemplary embodiment of the present invention and even if the sensor has been completely cooled to an ambient temperature, the dual shield design will allow the heater to heat the sensing element faster than the previous designs as the thermal barrier of the cavity between the inner shield and the outer shield will minimize convection losses. Moreover, and since the outer wall of the outer shield does not comprise any openings aligned with the exhaust flow path and the thermal barrier of the cavity between the inner shield and the outer shield surrounds the sensor, the deleterious effects (e.g., lengthening of sensor heat up time) of colder exhaust gases (e.g., at engine start up) will also be limited. In addition, the required power for the heater will also be reduced.

Accordingly, and in vehicular applications it is desirable to have a shorter light-off time as it allows for quicker air/fuel control, which provides better emission control.

It is contemplated that exemplary embodiments of the shield assembly disclosed herein can be utilized with a plurality of types of gas sensors and not limited to stoichiometric sensors. For example, the shield assembly can be used for oxygen sensors such as lamada, universal, and linear sensors, and the like. Additionally, the shield assembly can be used for gas sensors analyzing the following gases: Nitrogen Oxide (NOx), Hydrocarbon (HC), Carbon Monoxide (CO), Anhydrous Ammonia (NH3), and any others requiring a heated sensor element.

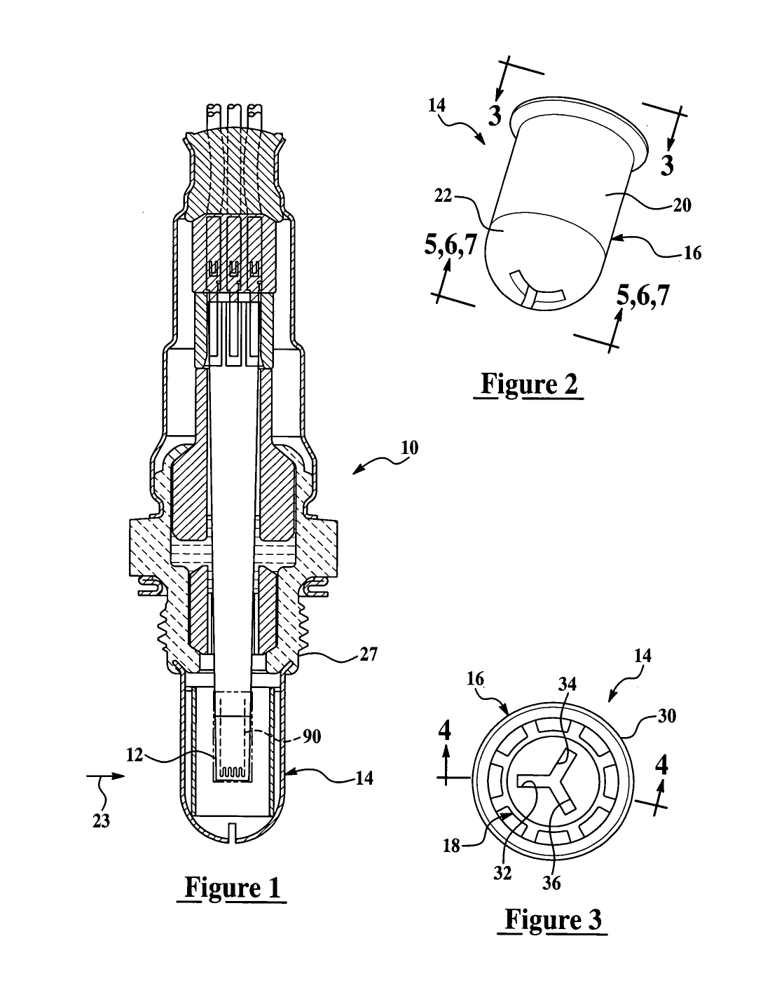

Referring now to FIGS. 1-4, a gas sensor 10 for determining a concentration of components of a gas is illustrated. Gas sensor 10 includes a sensing member 12 and a shield assembly 14 disposed over at least a portion of sensing member 12. Shield assembly 14 is provided to protect sensing member 12 from contaminates in an environment in which gas sensor 10 is exposed thererto, while allowing the gas to flow into an interior region of shield assembly 14. Shield assembly 14 is also configured to maintain the interior region within a desired temperature range for an optimal performance of gas sensor 10.

In an exemplary embodiment, shield assembly 14 includes an outer shield 16 and an inner shield 18 disposed within outer shield 16. Outer shield 16 is provided to hold inner shield 18 so sensing member 12 can be received within inner shield 18. Inner shield 18 is configured so that an elevated temperature level of fluids or gases within an interior region or cavity between outer shield 16 and inner shield 18 aids in reducing convection losses of the shield assembly, which in turn will reduce the time required to bring the sensing element into an operational temperature range. In an exemplary embodiment, inner shield 18 is a metal inner shield, for example, a stainless steel inner shield formed by a deep drawing process. In addition, the outer shield 16 is also be formed by a deep drawing process or equivalents thereof. Non-limiting materials contemplated for the inner and outer shields are inconnel 600, 300 series stainless steel and equivalents thereof.

In one exemplary embodiment, outer shield 16 and inner shield 18 are constructed of a substantially similar material. In addition, outer shield 16 and/or inner shield 18 are constructed from a material that contributes to maintaining the interior region or cavity between outer shield 16 and inner shield 18 at the temperature level within the desired or elevated temperature range. In an exemplary embodiment and after the sensor has been brought to an operational temperature and the heater is turned off, a temperature level in the interior region is at a higher temperature level than a temperature level in a region outside outer shield 16, wherein the heated interior region of the cavity between the inner and outer shield functions as a thermal blanket to aid in maintaining an elevated temperature range within the shield assembly. The thermal blanket is useful in reducing cooling of sensing member 12 in cold environments. Additionally, maintaining a higher temperature level within inner shield 18 aids in burning off contaminates that may enter the interior region of inner shield 18 as well as reducing the time required to heat the sensor element with an integral heater, should the heater be turned back on prior to the cavity being cooled to an ambient temperature.

In an exemplary embodiment, outer shield 16 includes an elongated outer wall 20 and a tip portion 22 having a hollow interior region for receiving inner shield 18 therein. In one non-limiting exemplary embodiment, outer shield 16 is formed from a deep draw process wherein tip portion 22 is integrally formed with outer wall 20. Outer wall 20 extends from a first end 26 to a second end 28. As shown, outer wall 20 is configured to be constructed without any openings that will be aligned with an exhaust gas flow path, which is illustrated by arrow 23 when the gas sensor is for example, secured to a housing of an exhaust gas treatment device or exhaust pipe or conduit. First end 26 defines an aperture 29 configured to allow inner shield 18 to be received into the hollow interior region. First end 26 is also configured to be secured to an outer shell 27 of gas sensor 10. For example, first end 26 is secured to outer shell 27 by a cold forming process. In an exemplary embodiment, first end 26 includes a flange member 30 extending away from first end 26, wherein flange member 30 is secured to outer shell 27. In an alternative exemplary embodiment, first end 26 includes a plurality of spaced flange members secured to outer shell 27. In another exemplary embodiment, first end 26 is secured to outer shell 27 by a welding operation.

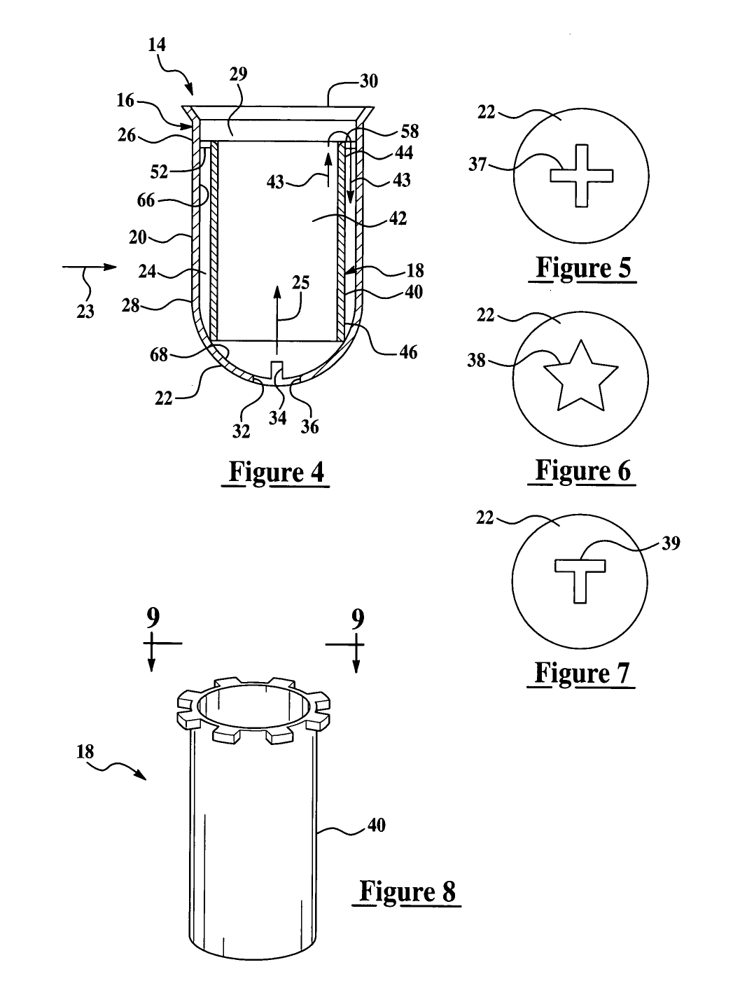

Tip portion 22 includes an opening configured to allow the gas to flow into the shield assembly. In an exemplary embodiment, the opening is positioned in tip portion 22 so gas flows through the opening into the hollow interior region of the shield assembly in a flow direction 25 (shown in FIG. 4). In one non-limiting example, flow direction 25 is perpendicular to a direction of exhaust gases flowing past the sensor (arrow 23). By positioning the opening within tip portion 22 and not within outer wall 20 of outer shield 16 heavier contaminates, like moisture and solid particles that may be within the gas flow, will not likely restrict the opening or contact sensing member 12. In another exemplary embodiment, the opening is also configured to allow contaminates that may have entered into the shield assembly to egress from the shield assembly. Moreover, cooler exhaust gases are prevented from directly aligning with the sensing element.

In addition, and in accordance with an exemplary embodiment of the present invention, the dual shield design provides yet another improvement over the prior designs. Here the opening in the tip portion and the inner shield are aligned to provide a non-tortuous pathway for exhaust gases to be exposed to the sensor. However, these aligned openings are offset from the exhaust flow path at for example, a ninety degree angle. Thus, there is a direct non-tortuous flow path through the inner and outer housings into the inner cavity of shield housing the sensing element however, the opening in the tip portion is not-aligned with a flow path of the engine exhaust.

This provides an improvement over all other dual shield designs, which have openings in the outer shield that are aligned with the exhaust flow path but not aligned with the opening in the inner shield so as to provide a tortuous pathway for exhaust gasses to flow into the sensing member. These designs were provided to protect the element from water and other contaminants in the exhaust stream.

In general, the response time of the sensor (e.g., time to indicate changes in the exhaust gas composition (i.e. oxygen content for switching sensors or wide range sensors)) is directly influenced by the shield design chosen as the passage ways into the shield will affect this response time. Moreover, and as the sensor is used in applications the shielding may become clogged, which ultimately affects the sensor's response time. Accordingly, it is desirable to have the response time of the sensor to be the same at the end of its specified life as it was at the time it was first installed in the engine.

For applications where there are excessive particulate contaminants in the exhaust stream (i.e. diesel engines), the inventors of exemplary embodiments of the present invention have found that these contaminants plug the openings in normal shield configurations (e.g., openings aligned with the exhaust flow path) because the tortuous pathway that is desirable for protecting the sensor element from such things as water impingement will also slow down the flow of the exhaust stream to such a point that solid contaminants such as soot in diesel engine exhaust deposit out and plug the tortuous pathway and thereby slow down the exchange of exhaust gasses to the inner shield cavity thereby slowing the response time of the sensor to exhaust composition changes. In other words, as the sensor ages the response time becomes longer due to the openings being clogged. This reduction in response time is not desirable and must either be compensated for by engine calibration or by instituting a high temperature cleaning cycle to the engine cycle. Neither of these two approaches works well.

Moreover and in diesel engine applications, the diesel exhaust is much cooler than gasoline engine exhaust (e.g., 400-500 degrees Celsius) and the flow rate is much faster thus, diesel engine applications provide a cooler exhaust at a higher flow rate as well as a greater amount of contaminates. Thus, exemplary embodiments of the present invention are particularly suited to diesel exhaust applications although not specifically limited to diesel applications.

Exemplary embodiments of the present invention are not subject to this plugging phenomenon since the only pathway for exhaust gas into the inner shield chamber is through the Y hole or other equivalent opening configuration and since this Y hole is positioned at 90 degrees to the exhaust flow, it does not plug. Also, any contaminants that tend to stick to the end of the shield are abraded away by other contaminants traveling in the exhaust stream. This is aided by the bullet nosed shape or curved tip portion 22 as well as the fast flow rate encountered in diesel applications. Any soot contaminants that manage to make the 90 degree turn and do get into the inner cavity will either be sucked out during the next engine pulse or burned up by the high temperature being maintained in the cavity by the heater. Moreover, locating the openings directly below the sensing element allows the contaminants to settle out via gravity through the openings in the inner and outer shields.

Thus, an exemplary embodiment of the present invention is a shield that does not plug with solids contaminants such as soot, is self cleaning, and therefore does result in a change in the response time during the life of the sensor.

In an exemplary embodiment, the opening in the tip portion is configured to permit an amount of gas to reach sensing member 12. In an alternative exemplary embodiment, the opening meters the amount of the gas that can reach sensing member 12 to prevent an excessive amount of the gas from enveloping sensing member 12. In an exemplary embodiment, tip portion 22 includes an opening defined by at least one elongated aperture. For example, tip portion 22 includes three apertures, 32, 34, and 36 each extending radially outward from a central area of tip portion 22 defining a “Y” shaped aperture. Sensing member 12 is exposed to the gas when the gas is routed through apertures 32, 34 and 36 into hollow interior region 42 of outer shield 16. In an alternative exemplary embodiment, tip portion 22 includes an opening that forms a cross shaped aperture 37, a star shaped aperture 38, or a “T” shaped aperture 39, as illustrated in FIGS. 5, 6 and 7, respectively. In another alternative exemplary embodiment, the opening can comprise a combination of shapes. In another alternative exemplary embodiment, the opening can be configured where one aperture does not intersect another aperture. Further details of the openings or apertures maybe found in U.S. Pat. No. 6,691,553.

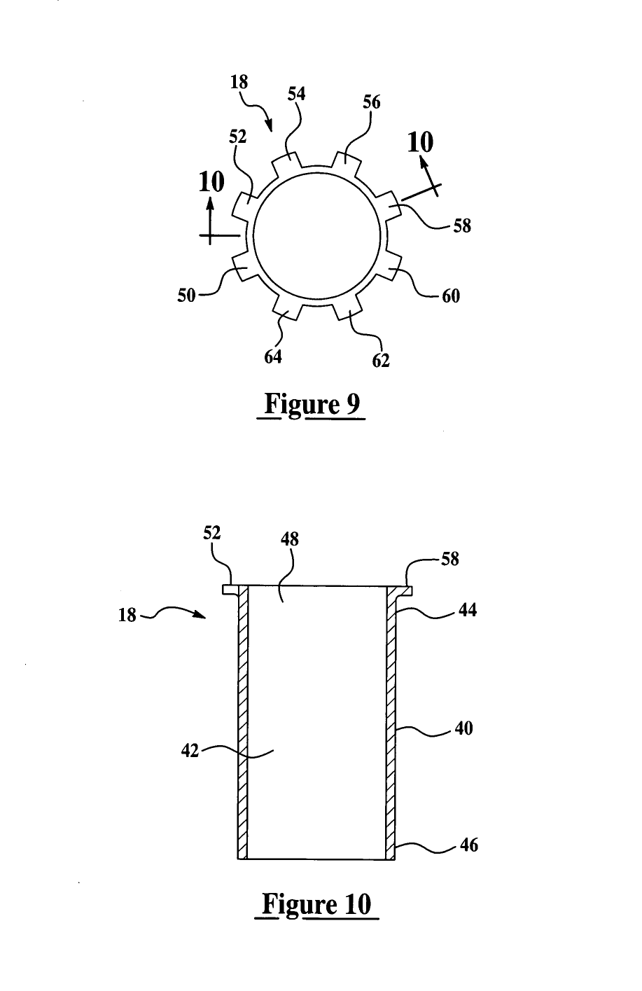

Referring now to FIGS. 8-10, an inner shield constructed in accordance with an exemplary embodiment is illustrated. Inner shield 18 includes an inner elongated wall 40 and at least one flange member or portion. In one embodiment, the flange member traverses the entire periphery of the inner shield and in another exemplary embodiment, the flange portion is configured to have openings located therein. Inner wall 40 defines a cavity or a hollow interior region 42 for receiving at least a portion of sensing member 12 therein. The flange portion is provided for positioning inner wall 40 within the outer shield. In an exemplary embodiment, the flange portion includes at least one aperture so that gas that flows into hollow interior region 42 can flow into the hollow interior region or cavity 24 disposed between outer wall 20 and inner wall 40. In another embodiment, there are no apertures and the flange portion and the inner wall completely seal the cavity between the inner and outer walls. In an exemplary embodiment and when the flange has an opening, gas flows along a tortuous flow path 43 from hollow interior region 42 through the aperture into the hollow interior region or cavity 24 disposed between outer wall 20 and inner wall 40. Here and if the exhaust gas is colder than an operational temperature of the sensor (e.g., cold engine start) the gas is heated by the heater of the sensor element and travels into the cavity 24. In accordance with an exemplary embodiment, heated gas between outer wall 20 and inner wall 40 functions as a thermal blanket to aid in maintaining the desired temperature range of sensing member 12 within hollow interior region 42 as well as reducing the time to heat the sensor to an operational temperature during a cold start.

In an exemplary embodiment, inner wall 40 extends from a first open end 44 to a second open end 46. First end 44 defines an aperture 48 configured to allow sensing member 12 to be received into hollow interior region 42. In an exemplary embodiment, aperture 48 traverses the entire width of tip portion 22. In an alternative exemplary embodiment, aperture 48 does not have a constant configuration along a length of inner wall 40.

In an exemplary embodiment, a plurality of spaced apart flange portions or tab portions 50, 52, 54, 56, 58, 60, 62, and 64 extend in an outward direction from a periphery of inner wall 40 at first end 44 toward an inner surface of the outer wall of the outer shield when the inner shield is disposed within the outer shield. The spaces between tabs 50, 52, 54, 56, 58, 60, 62, and 64 are the apertures through which the gas flows along tortuous paths 43 from hollow interior region 42 into hollow interior region 24 between outer wall 20 and inner wall 40. In an alternative exemplary embodiment, any number of flanges or tabs are used to position inner wall 40 within outer wall 20 via contact between the tabs and the inner surface of the outer wall, wherein at least one aperture allows the gas to flow through the flange member(s) into hollow interior region 24 between outer wall 20 and inner wall 40.

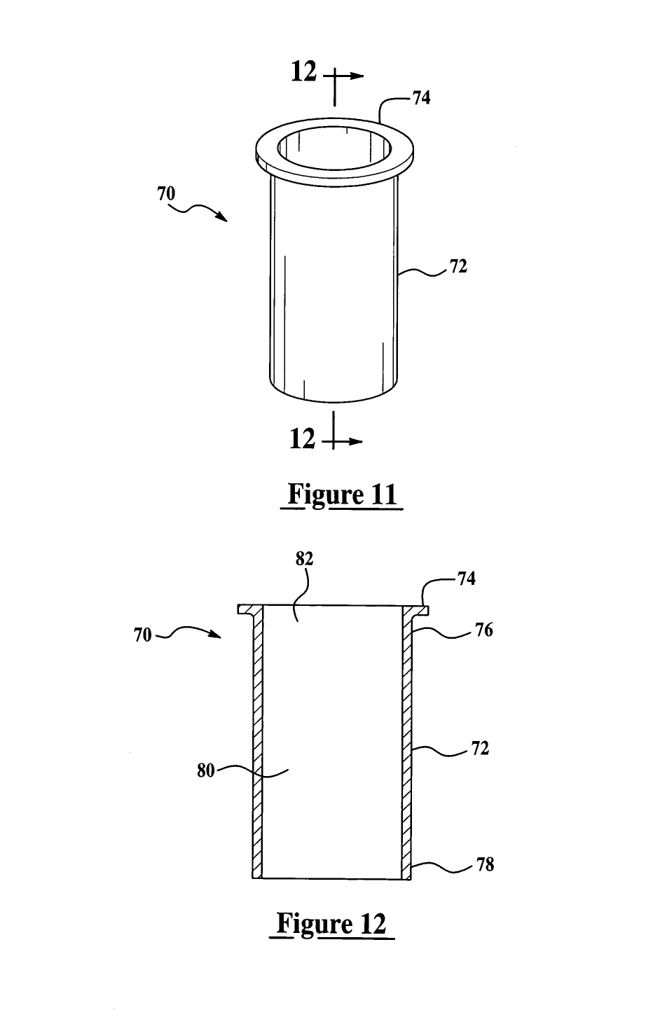

Referring now to FIGS. 11 and 12, another exemplary embodiment of an inner shield 70 that can be utilized instead of inner shield 18 is illustrated. Inner shield 70 includes an inner elongated wall 72 and a flange portion 74. In accordance with an exemplary embodiment, flange portion 74 does not have any openings or apertures. Inner wall 72 extends from a first open end 76 to a second open end 78. An inner surface of inner wall 72 defines a cavity 80 configured for receiving at least a portion of sensing member 12 therein. An inner surface of inner wall 72 at first end 76 defines an aperture 82 configured to allow sensing member 12 to be received into cavity 80. Flange portion 74 is positioned at first end 76 of inner wall 72 and extends away from a periphery of the inner wall in an outward direction to contact the inner surface of the outer wall of the outer shield when the inner shield is disposed within the outer shield.

In this embodiment, inner shield 70 is used instead of inner shield 18 of shield assembly 14 shown in FIG. 4. In an exemplary embodiment, an interior region or cavity is defined between outer shield 16 and inner shield 70 when flange portion 74 extends to an inner surface of outer wall 20 and second end 78 of inner wall 72 extends to an inner surface of tip portion 22 of the outer shield. Thus, no openings or apertures are provided between the inner shield and the outer shield. Furthermore and in one embodiment, the interior region or cavity is completely sealed off via a welding or cold forming process. In an exemplary embodiment and after heater shut down, the temperature level within the interior region remains at a higher temperature than the cavity of the inner shield because the interior region is substantially closed off compared to the cavity of the inner shield. Thus, in an exemplary embodiment, the interior region functions as a thermal barrier about cavity 80 of inner shield 70 and the sensing member of the gas sensor disposed in cavity 80. Heated gases in the interior region or cavity reduce the rate of cooling the shield assembly. For example and in one embodiment wherein the gas sensor has been heated up to an operational temperature and has not cooled off to an ambient temperature, the heated gas prevents excessive cooling of the shield assembly when the shield assembly is subject to colder exhaust gases (e.g., exhaust gases at initial engine start up when the engine has been shut off for a while). This heated gas reduces the cooling rate of the sensor element when the sensing element is disposed in cool applications such as exhaust gases from a diesel engine. When the cooler exhaust gases enter a previously heated cavity, heat loss from the heated cavity towards the interior region is slowed by the previously heated interior region, which was heated to a temperature level that is higher than the cooler exhaust gases. Thus, the time require to heat the sensor element to an operational temperature is shortened.

In an exemplary embodiment, the inner shield is configured to be secured to the outer shield via any suitable attachment process. In an exemplary embodiment, tabs 50, 52, 54, 56, 58, 60, 62, and 64 of inner shield 18 or flange portion 74 of inner shield 70 are welded to an interior surface 66 of outer wall 20. Alternatively, the flanges or tabs of the inner shield are press fit into outer shield 16. In an exemplary embodiment, the second end of the inner wall of the inner shield contacts an inner surface 68 of tip portion 22 when the inner shield is secured to outer shield 16, thereby providing a rigid point of securement between the two shield portions.

In an exemplary embodiment, gas sensor 10 having the shield assembly further includes a heating member 90 for heating sensing member 12 to the temperature level within the desired temperature range. In one non-limiting exemplary embodiment heating member 90 comprises a pattern of conductive material wherein an applied voltage will cause the conductive material to provide the desired amount of heat. Accordingly, and by reducing the amount heat required from the heater exemplary embodiments of the present invention will also reduce the amount of power required to operate the heater in preferred ranges. Of course, in an alternative embodiment the heating member may be positioned in other locations to heat sensing member 12. The heating member also elevates a temperature level within the interior region between the outer shield and the inner shield, thereby creating the thermal blanket to aid in maintaining the desired temperature range of sensing member 12 for an amount of time. Thus, and after the heater is shut down the thermal blanket will reduce the time necessary to reheat the sensing element to an operation temperature. Alternatively, and if the sensor and cavity of the shield assembly has been completely cooled to an ambient temperature less than that required for sensor operation, the shield assembly of exemplary embodiments of the present invention will reduce the time required to heat up the sensor as the cavity between the inner shield and the outer shield aids in reducing the convection losses to cooler gases or exhaust gases surrounding the shield assembly. This is also facilitated by the fact that the outer wall does not have any openings aligned with the flow path of the exhaust gas being sampled.

This is particularly useful during cold starts when the oxygen readings of the gas sensor are required to vary the air-to fuel ratio in order to reduce the engine emissions. Moreover, and if a cold exhaust (e.g., cold start) is being applied to the outer shell and the heater is heating up the sensing element, the cavity disposed between the inner and outer layers acts like an insulating layer, which in conjunction with the tip openings being located at a 90 degree angle or other non-aligned position (less than or greater than 90 degrees) with regard to the exhaust gases flowing in the direction of arrow 23, allows the shield assembly of exemplary embodiments of the present invention to reduce the required “time to activity” or “light-off-time” as the flow direction of the cool exhaust gases will not be directly aligned with the tip opening of the shield assembly.

In an exemplary embodiment, gas sensor 10 provides data to a vehicle engine system corresponding to a response from sensing member 12. A response time that gas sensor 10 takes to provide the data to the vehicle engine system is shortened because the temperature level of sensing member 12 is maintained within hollow interior region of the inner shield within the desired temperature range, due to the thermal blanket between the outer and inner shield. The thermal blanket is also beneficial to aid in preventing damage to a sensitive sensing member due to thermal shock when colder matter contacts the sensing member. For example, water in vehicle exhaust can damage,a ceramic sensing member when the water contacts the ceramic sensing member. Additionally, when the vehicle has not been operating so heated exhaust gases have not contacted the sensing member for some time or the heating member cycles from off to on, the thermal blanket allows the sensing member to be brought up to a desired temperature level faster, because the thermal blanket has maintained the sensing member at a temperature level for a longer period of time than a shield assembly having only one wall surrounding the sensing member.

Accordingly and in accordance with exemplary embodiments of the present invention, the shield assembly comprises an inner shield disposed within an outer shield wherein the only apertures or openings into the shield assembly are positioned such that they are not aligned with a flow path of an exhaust gas stream the sensor is disposed in. In addition, the shield assembly is configured such that the cavity or interior region is defined and disposed between the inner and outer shield. In accordance with an exemplary embodiment, the cavity surrounds an outer periphery of the inner shield and is completely sealed or closed off by a flange portion of the inner shield and another portion of the inner shield making contact with the outer shield. Alternatively, the cavity is in fluid communication with an interior region of the inner shield through at least one opening disposed in the flange portion.

Regardless of whether the cavity is completely sealed off or has an opening therein the cavity and the configuration of the shield assembly (e.g., opening not aligned with gas flow and disposed in tip portion) reduces the time to heat the sensor to an operational temperature during sensor operation as well as reducing the power requirements of the heater in order to heat and maintain the sensor at an operational temperature, non-limiting examples of sensor operation include the following situations: cold engine start (e.g., cooler exhaust gases) and sensor has cooled to ambient temperature as well as operation thereafter (e.g., heating and maintaining the sensor element at the desired operational temperature after it has been heated up); cold engine start and sensor has still retained heat from prior operation (e.g., not completely cooled down due to heated gases in the cavity between the inner and outer walls) as well as operation thereafter (e.g., heating and maintaining the sensor element at the desired operational temperature after it has been heated up); warm engine start (e.g., exhaust gases having a temperature higher than cold engine start and exhaust gases will reach operational temperature faster than cold engine start) and sensor has still retained heat from prior operation (e.g., not completely cooled down due to heated gases in the cavity between the inner and outer walls) as well as operation thereafter (e.g., heating and maintaining the sensor element at the desired operational temperature after it has been heated up); and warm engine start (e.g., exhaust gases having a temperature higher than cold engine start and exhaust gases will reach operational temperature faster than cold engine start) and sensor has cooled to ambient temperature as well as operation thereafter (e.g., heating and maintaining the sensor element at the desired operational temperature after it has been heated up).

In any of the aforementioned scenarios the cavity between the inner and outer shields will reduce the time to bring the sensor to an operational temperature for example in the case of an oxygen sensor the operation temperature being necessary for ionic exchange or transfer in an electrolyte of an electrochemical cell. One non-limiting example of such a sensor is found in U.S. Pat. No. 6,447,658 the contents of which are incorporated herein by reference thereto.

Accordingly, the cavity between the inner and outer shields limits or reduces the time to heat up the sensor element as the cavity provides a thermal barrier that limits or reduces convection losses by reducing the impact of cool exhaust gases during sensor heat up and/or retaining heat via heated gases in the cavity for a longer period of time after the heater of the sensor and the engine producing the exhaust gases has been shut down thus, reducing the time to heat the sensor back up to an operational temperature should the sensor be activated or used prior to the shield assembly being cooled to an ambient temperature. Moreover, theses features are also useful in the event that the engine and the shield assembly has completely cooled down as the cooler exhaust gases do not directly align with the sensor element and the internally generated heat from the heater of the sensor is retained in the cavity surrounding the inner shield. In addition, theses features are also useful in the event that the engine has also not completely cooled down thus warmer exhaust gases and the shield assembly of exemplary embodiments of the present invention will further reduce the time to heat the sensor assembly up to an operational temperature. Finally, exemplary embodiments of the present invention also reduce the required power consumption of the heater as the heated cavity reduces convection losses thus reducing the amount of heat required from the heater.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the present application.

What is claimed is:

1. A shield assembly for protecting a sensing element of a gas sensor, the shield assembly comprising:
an outer shield comprising an elongated outer wall having a first end and a second end and a tip portion disposed across the second end of the outer wall, the tip portion having at least one elongated aperture extending therethrough and the elongated wall is configured to not have any openings between the first end and the second end;
an inner shield comprising an inner elongated wall disposed within the elongated outer wall, the inner elongated wall having a first open end and a second open end and a flange portion extending from a periphery of the first open end of the inner elongated wall, the flange portion being configured to make contact with the elongated outer wall when the inner elongated wall is inserted therein and the second open end makes contact with the tip portion to define a thermal barrier comprising a cavity located between the inner elongated wall and the elongated outer wall, the second open end being aligned with the at least one elongated aperture to provide a non-tortuous flow path from the at least one elongated aperture to the second open end of the inner shield; and
wherein convection losses from an interior region defined by the inner elongated wall, to the elongated outer wall, are slowed by heated fluid disposed in the cavity between the elongated outer wall and the inner elongated wall.

2. The shield assembly as in claim 1, wherein the flange portion further comprises at least one aperture extending therethrough, the at least one aperture allowing fluid communication between the cavity and the interior region.

3. The shield assembly as in claim 1, wherein the flange portion further comprises a plurality of tabs depending away from the periphery of the first open end of the inner elongated wall, wherein the plurality of tabs are configured to define a plurality of apertures, each of the plurality of apertures allowing fluid communication between the cavity and the interior region.

4. The shield assembly as in claim 1, wherein the elongated outer wall is a first substantially tubular member and the inner elongated wall is a second substantially tubular member inserted in the first substantially tubular member, the second substantially tubular member being smaller than the first substantially tubular member and wherein no openings are provided in the flange portion or the inner elongated wall thereby, completely sealing the cavity with the inner elongated wall, the flange portion and the outer elongated wall.

5. The shield assembly as in claim 4, wherein the tip portion is a curved member.

6. The shield assembly as in claim 1, wherein the at least one elongated aperture forms a Y-shaped aperture in the tip portion.

7. The shield assembly as in claim 1, wherein the at least one elongated aperture forms a T-shaped aperture in the tip portion.

8. The shield assembly as in claim 1, wherein the at least one elongated aperture forms a star-shaped aperture in the tip portion.

9. A gas sensor, comprising:
an outer shell,
a sensing member extending from the outer shell; and
a shield assembly coupled to the outer shell, the shield assembly having an outer shield comprising an elongated outer wall and an inner shield comprising an inner elongated wall, the elongated outer wall having a first end and a second end and a tip portion disposed across the second end of the outer wall, the tip portion having at least one elongated aperture extending therethrough and the elongated wall is configured to not have any openings between the first end and the second end, the inner elongated wall disposed within the elongated outer wall, the inner elongated wall having a first open end and a second open end and a flange portion extending from a periphery of the first open end of the inner elongated wall, the flange portion being configured to make contact with the elongated outer wall when the inner elongated wall is inserted therein and the second open end makes contact with the tip portion to define a thermal barrier comprising a cavity located between the inner elongated wall and the elongated outer wall, the second open end being aligned with the at least one elongated aperture to provide a non-tortuous flow path from the at least one elongated aperture to the second open end of the inner shield; and
wherein convection losses from an interior region defined by the inner elongated wall, to the elongated outer wall, are slowed by heated fluid disposed in the cavity between the elongated outer wall and the inner elongated wall.

10. The gas sensor as in claim 9, wherein the flange portion further comprises at least one aperture extending therethrough, the at least one aperture allowing fluid communication between the cavity and the interior region.

11. The gas sensor as in claim 9, wherein the flange portion is defined by a plurality of tabs depending away from the periphery of the first open end of the inner elongated wall, the plurality of tabs defining a plurality of apertures providing fluid communication between the cavity and the interior region.

12. The gas sensor as in claim 9, wherein the elongated outer wall is a first substantially tubular member and the inner elongated wall is a second substantially tubular member inserted in the first substantially tubular member, the second substantially tubular member being smaller than the first substantially tubular member and wherein no openings are provided in the flange portion or the inner elongated wall thereby, completely sealing the cavity with the inner elongated wall, the flange portion and the outer elongated wall.

13. The gas sensor as in claim 12, wherein the tip portion is a curved member and the gas sensor is configured to be secured to a housing of an exhaust treatment device so that the at least one opening in the tip portion is not aligned with an exhaust gas flowing past the shield assembly.

14. The gas sensor as in claim 9, wherein the sensing member is an oxygen sensing member.

15. The gas sensor as in claim 9, further comprising a heating member for heating the sensing member to a temperature level within a desired temperature range, wherein the shield assembly reduces a time period and a power requirement to heat the sensing member to the temperature level by positioning a thermal barrier between the inner shield and the outer shield.

16. The gas sensor as in claim 9, wherein the at least one elongated aperture forms a Y-shaped aperture in the tip portion.

17. The gas sensor as in claim 9, wherein the at least one elongated aperture forms a T-shaped aperture in the tip portion.

18. The gas sensor as in claim 9, wherein the at least one elongated aperture forms a star-shaped aperture in the tip portion.

19. A method for limiting convection losses in a gas sensor, the method comprising:
heating a fluid in an interior region disposed between an elongated outer wall of an outer shield and an inner elongated wall of an inner shield disposed within the outer shield with a heater of a sensing element disposed within the inner shield, wherein convection losses from an interior region defined by the inner elongated wall, to the elongated outer wall, are slowed by the heated fluid disposed in the interior region between the elongated outer wall and the inner elongated wall.

20. The method of claim 19, wherein the elongated outer wall has a tip portion disposed across an end of the elongated outer wall, the tip portion having at least one elongated aperture extending therethrough and in fluid communication with the interior region defined by the inner elongated wall, the at least one elongated aperture of the tip portion being aligned with an opening in the inner shield to provide a non-tortuous flow path from the at least one elongated aperture to the opening of the inner shield, wherein the gas sensor is configured so that the at least one opening in the tip portion is not aligned with an exhaust gas flowing past the outer shield and the elongated outer wall is configured to not have any openings extending therethrough and the inner shield and the outer shield reduce a time period and a power requirement to heat the sensing member to an operational temperature level.
